(19) United States
(12) Patent Application Publication
(10) Pub. No.: US 2024/0386025 A1
(43) Pub. Date: Nov. 21, 2024

(54) DYNAMIC ADAPTABILITY TECHNIQUES IN SHARED DATA MODELS

(71) Applicant: Delphi.IO Ltd., Tel Aviv (IL)

(72) Inventors: Eyal FIRSTENBERG, Sunnyvale, CA (US); Sarah LEVY SCHREIER, Tel Aviv (IL)

(73) Assignee: Delphi.IO Ltd., Tel Aviv (IL)

(21) Appl. No.: 18/669,063

(22) Filed: May 20, 2024

Related U.S. Application Data
(60) Provisional application No. 63/503,012, filed on May 18, 2023.

(51) Int. Cl. G06F 16/248; G06F 8/52; G06F 8/65; G06F 16/245

(52) U.S. Cl. CPC G06F 16/248; G06F 8/52; G06F 8/65; G06F 16/245

(57) ABSTRACT

A system and method for dynamically adapting a query and shared data model, is presented. The method includes receiving a structured query directed to a shared data model; apply a plurality of heuristics to the received structured query and the shared data model; detecting a conflict between a first element of the structured query and a first element of the shared data model based on a first heuristic of the plurality of heuristics; generating, in response to detecting a first result of applying the first heuristic, a new structured query based on the received structured query and the first result; generating, in response to detecting a second result of applying a second heuristic of the plurality of heuristics, a modified shared data model, based on the shared data model and the second result.

### CROSS-REFERENCE TO RELATED APPLICATIONS

This application claims the benefit of U.S. Provisional Patent Application No. 63/503,012 filed May 18, 2023, the contents of which are incorporated by reference herein.

### TECHNICAL FIELD

The present disclosure relates generally to data analytics and specifically to providing dynamic adaptability of a shared data model in structured query execution.

### BACKGROUND

In the realm of data analytics, modern data teams across various industries are increasingly adopting an approach that emphasizes the separation of data generation from data application. This allows them to achieve greater efficiency in leveraging data by loading it in its raw form (referred to as “sourced aligned”) and subsequently transforming it through a series of manipulations into structures that align with the specific business data application.

This transformation process, commonly known as ELT (Extract, Load, Transform), entails capturing both the intricacies of the data source, including its nuances and idiosyncrasies, and the comprehensive understanding of the business objectives, encompassing precise definitions of each business term, concepts, Objectives and Key Results (OKRs), and Key Performance Indicators (KPIs).

Given that both the data generators and the business needs are subject to constant changes, the shared data model captured in this ELT layer is in a perpetual state of evolution. Managing this ongoing evolution poses a significant challenge for data teams, particularly as they expand in size and become more organizationally fragmented.

On one hand, the teams aim to have the freedom to build the necessary data applications for the business without being hindered by the intricacies of the shared data model. On the other hand, the shared data model must remain consistent to ensure the consistency of the data applications themselves.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a structured query directed to a shared data model. Method may also include apply a plurality of heuristics to the received structured query and the shared data model. Method may furthermore include detecting a conflict between a first element of the structured query and a first element of the shared data model based on a first heuristic of the plurality of heuristics. Method may in addition include generating a new structured query based on the received structured query and a first result, in response to detecting the first result of applying the first heuristic. Method may moreover include generating a modified shared data model based on the shared data model and a second result, in response to detecting the second result of applying a second heuristic of the plurality of heuristics. Other embodiments of this aspect include corresponding computer systems, apparatus, and computer programs recorded on one or more computer storage devices, each configured to perform the actions of the methods.

Implementations may include one or more of the following features. Method may include: generating a change request to generate the modified shared data model; and initiating a regression test on the change request. Method may include: identify an impacted software application utilizing the modified shared data model based on a result of the regression test. Method may include: generating the modified shared data model for the impacted software application; and assigning an unimpacted software to the shared data model. Method may include: generating a software application update to update the impacted software application to utilize the modified shared data model. Method may include: generating a binary code based on the impacted software application; and replacing a portion of code of the impact software application with the generated binary code. Method may include: detecting a dimension identifier in the received structured query which is not defined in the shared data model; and detecting the conflict based on the detected dimension. Method may include: detecting a measure identifier in the received structured query which is not defined in the shared data model; and detecting the conflict based on the detected measure. Implementations of the described techniques may include hardware, a method or process, or a computer tangible medium.

In one general aspect, non-transitory computer-readable medium may include one or more instructions that, when executed by one or more processors of a device, cause the device to: receive a structured query directed to a shared data model; apply a plurality of heuristics to the received structured query and the shared data model; detect a conflict between a first element of the structured query and a first element of the shared data model based on a first heuristic of the plurality of heuristics; generate a new structured query based on the received structured query and the first result, in response to detecting a first result of applying the first heuristic; and generate a modified shared data model based on the shared data model and the second result, in response to detecting a second result of applying a second heuristic of the plurality of heuristics. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: receive a structured query directed to a shared data model. System may in addition apply a plurality of heuristics to the received structured query and the shared data model. System may moreover detect a conflict between a first element of the structured query and a first element of the shared data model based on a first heuristic of the plurality of heuristics. System may also generate a new structured query based on the received structured query and the first result, in response to detecting a first result of applying the first heuristic. System may furthermore generate a modified shared data model based on the shared data model and the second result, in response to detecting a second result of applying a second heuristic of the plurality of heuristics. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: generate a change request to generate the modified shared data model; and initiate a regression test on the change request. System where the memory contains further instructions which when executed by the processing circuitry further configure the system to: identify an impacted software application utilize the modified shared data model based on a result of the regression test. System where the memory contains further instructions which when executed by the processing circuitry further configure the system to: generate the modified shared data model for the impacted software application; and assign an unimpacted software to the shared data model. System where the memory contains further instructions which when executed by the processing circuitry further configure the system to: generate a software application update to update the impacted software application to utilize the modified shared data model. System where the memory contains further instructions which when executed by the processing circuitry further configure the system to: generate a binary code based on the impacted software application; and replace a portion of code of the impact software application with the generated binary code. System where the memory contains further instructions which when executed by the processing circuitry further configure the system to: detect a dimension identifier in the received structured query which is not defined in the shared data model; and detect the conflict based on the detected dimension. System where the memory contains further instructions which when executed by the processing circuitry further configure the system to: detect a measure identifier in the received structured query which is not defined in the shared data model; and detect the conflict based on the detected measure. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example diagram of a system for data conflict detection and resolution, implemented in accordance with an embodiment.

FIG. 2 is an example flowchart of a method for resolving conflict between a query and a shared data model, implemented in accordance with an embodiment.

FIG. 3 is an example flowchart of a method for adapting a shared data model to a data application, implemented according to an embodiment.

FIG. 4 is an example flowchart of a method for detecting a conflict between a query and a shared data model, implemented in accordance with an embodiment.

FIG. 5 is an example schematic diagram of a controller according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for dynamically adapting a shared data model, a query directed to a shared data model, a combination thereof, and the like. According to an embodiment, the system is configured to analyze a structured query. In an embodiment, the structured query is analyzed during an authoring process.

In certain embodiments, the system is configured to a conflict between a query and an existing shared data model. In an embodiment, the system is further configured to generate an alert in response to detecting the conflict. In some embodiments, the system is configured to apply a plurality of policies, rules, heuristics, combinations thereof, and the like, to an input including a query and a shared data model structure.

By detecting a conflict prior to deploying a query in a data application, conflicts are resolved early on, preventing the propagation of errors throughout the data applications.

In some embodiments, the system is configured to identify potential new business terms, metrics, relationships, models, a combination thereof, and the like based on received queries. According to an embodiment, the system generates a prompt for a user account to evaluate, publish, and the like, a new business term, a metric, a relationship, a model, a combination thereof, and the like, to enrich the shared data model. In an embodiment, the system is further configured to determine a user account having permission to implement a change based on the new business term, the metric, the relationship, the model, the combination thereof, and the like.

In some embodiments, the system is configured to incorporate a potential change. For example, in certain embodiments, the system is configured to generate computer code for the potential change, and automate the change management process. This allows for seamless transition of the shared data model from a first state to a second state, and ensures efficient and accurate application of the proposed modifications to the shared data model.

According to some embodiments, the system and methods disclosed allow data teams to strike a balance between the freedom to develop data applications tailored to the business needs and the necessity of maintaining a consistent shared data model. Data teams can navigate the complexities of evolving data landscapes, driving enhanced data analytics capabilities and delivering valuable insights to their organizations.

In this regard, it is recognized that conflict detection between a query and a shared data model, and proposed resolutions can be performed by a human. However, a human is not capable of applying a policy, a rule, a heuristic, a combination thereof, and the like, in a manner which is consistent and reliable, using objective criteria. This is because a human applies criteria in a subjective manner, and fatigue and mistakes lead to inconsistency even when attempting to apply a subjective criteria, resulting in an unreliable system. The disclosed system overcomes at least this challenge by applying a policy, a rule, a heuristic, and the like, using objective criteria, in a manner which is consistent, resulting in a reliable shared data model.

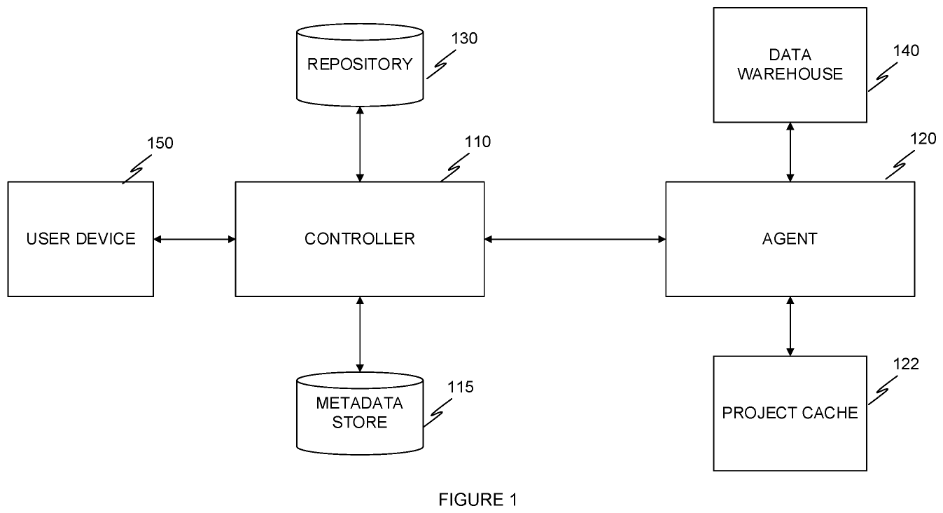

FIG. 1 is an example diagram of a system for data conflict detection and resolution, implemented in accordance with an embodiment. In an embodiment, a system for data conflict detection and resolution, also referred to as controller 110, is configured to access a repository 130 and extract therefrom a shared data model. In some embodiments, the controller 110 is configured to extract the shared data model by utilizing a credential, for example which provides access to an application programming interface (API) of a repository where a shared data model is stored.

In some embodiments, the shared data model includes a structured query expression, executable computer code, a combination thereof, and the like. In an embodiment, the shared data model is expressed in an extract, load, transform (ELT) standard, such as dbt™ (i.e., data build tool). For example, according to an embodiment, a shared data model is expressed as a dbt SQL model, which is defined using a SELECT statement. In other embodiments, a shared data model is expressed as a dbt Python model, defined as a function which returns a dataframe.

In an embodiment, the controller 110 is configured to retrieve, receive, and otherwise access a shared data model (e.g., stored on a repository 130), and further receive a query from a user device 150. In some embodiments, the query is a structured query, such as a SQL query. According to an embodiment, the controller 110 is configured to apply a policy, a rule, a heuristic, a combination thereof, and the like, to an input including a shared data model and a query. In some embodiments, a plurality of queries are received. For example, each query of the plurality of queries is used as a distinct input, according to an embodiment. According to another embodiment, the plurality of queries are utilized together in a single input.

In an embodiment, applying the policy, rule, heuristic, and the like, includes parsing the shared data model to detect an element such as a data field, a dimension, a measure, an aggregate, a formula, a sub-formula, a relationship, a combination thereof, and the like. In some embodiments, metadata indicating the data field, dimension, measure, etc., is extracted from the shared data model. Applying the policy further includes, according to an embodiment, parsing the received query to detect an element such as a predicate, a data field, a dimension, a measure, an aggregate, a formula, a sub-formula, a relationship, a combination thereof, and the like.

In some embodiments, the controller 110 is configured to compare a parsed element, extracted element, and the like, from the shared data model to a parsed element from the received query. For example, in an embodiment, a comparison is generated between a parsed element of the shared data model and a parsed element of the received query to detect a conflict. In some embodiments, the comparison is generated between a plurality of parsed elements of the shared data model and a plurality of parsed elements of the received query.

In an embodiment, the controller 110 is configured to serve a multi-tenant environment. For example, a first user account is associated with a first tenant having a first shared data model, and a second user account is associated with a second tenant having a second shared data model. In an embodiment, the controller 110 is configured to determine, for example by utilizing an identity and access management service, which data model is associated with a particular tenant, user account, and the like. In some embodiments, the query includes an access credential, identifier of a user account, and the like, which are utilized by the controller 110 for accessing a shared data model which the user account, for example associated with the user device 150, is authorized to access, view, and the like.

In some embodiments, the controller 110 is further configured to store metadata of the shared data model in a metadata store 115. In an embodiment, the input for the controller 110 includes a metadata value, and a received query. In some embodiments, the controller 110 is configured to generate metadata, for example based on accessing the shared data model from the repository 130. In an embodiment, the metadata includes a mapping between a table and a dbt model, a mapping between a view and a dbt model, a combination thereof, and the like.

In certain embodiments, an agent 120 is deployed, which is configured to build the shared data model, for example by generating an instruction for execution at a data warehouse 140. In an embodiment, the instruction includes an extract instruction, a load instruction, a transform instruction, a combination thereof, and the like. In some embodiments, the instruction includes a credential for accessing the data warehouse 140. In an embodiment, a data warehouse 140 is implemented as, for example, Snowflake®, Domo®, and the like.

In an embodiment, the instruction is generated by the controller 110. For example, in an embodiment, the controller 110 is configured to receive a query from the user device 150. The controller 110 is configured to apply a heuristic to the received query, for example to determine if the received query conflicts with the shared data model based on which the query is executed, according to an embodiment. In some embodiments, where the controller 110 detects a conflict (for example utilizing the methods discussed in more detail herein), the controller 110 is further configured to generate an instruction which modifies the query, modifies the shared data model, modifies the query and modifies the shared data model, stores another version of the data model, a combination thereof, and the like.

In certain embodiments, the instruction is sent to the agent 120 for execution on the data warehouse 140. In some embodiments, the instruction is executed by the controller 110, for example to modify, change, otherwise alter, and the like, the shared data model. In certain embodiments, execution of the instruction initiates storing a second version of the shared database model in the repository 130. In some embodiments, the second version of the shared database model is utilized for detecting conflict with a received query, while the previous shared database model is stored for allowing a data application to transition from the previous shared database model to the second version of the shared database model.

In certain embodiments, the agent 120 is further configured to maintain a project cache 122. In an embodiment, the project cache 122 includes a data structure which mirrors the shared database model. This is useful, for example, in increasing processing of I/O operations in a build.

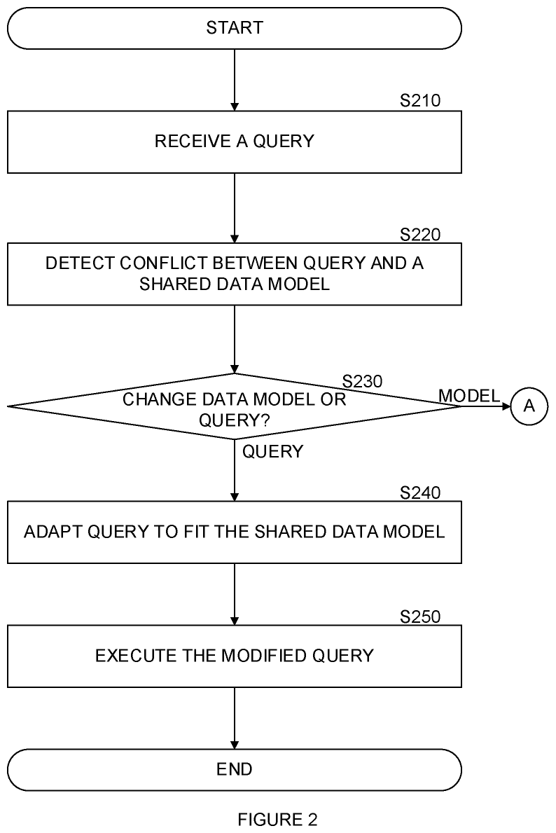

FIG. 2 is an example flowchart of a method for resolving conflict between a query and a shared data model, implemented in accordance with an embodiment. In some embodiments, a user device, such as user device 150 of FIG. 1 above, is configured to generate a data application. In an embodiment, the data application includes a query, such as a SQL statement. In an embodiment, a controller, such as controller 110, is configured to continuously detect and resolve conflicts between the queries as received in SQL statements, and a shared data model at which they are directed.

At S210, a query is received. In an embodiment, the query is a structured query, such as Structured Query Language (SQL) statement. In some embodiments, the query includes a SELECT statement. In an embodiment, the query is directed at a shared data model, expressed, for example, in an ELT standard. For example, according to an embodiment, the ELT standard is dbt.

In certain embodiments, a plurality of queries are received. In some embodiments, the plurality of queries are directed at a single shared data model. In an embodiment, a first plurality of queries are directed at a first shared data model, and a second plurality of queries are directed at a second shared data model. In some embodiments, each query of the plurality of queries is associated with a data application, a plurality of data applications, and the like.

At S220, a conflict is detected. In an embodiment, a conflict occurs where the query and the shared data model have a contradicting dimension definition, have a different name for an existing dimension, a new metric for an existing projection, have a relationship in the query that does not manifest in the shared data model, a combination thereof, and the like.

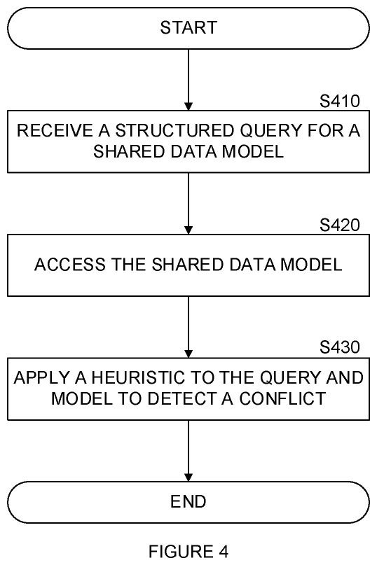

In certain embodiments, detecting a conflict includes detecting a new business term, a new metric, a new relationship, a new model, and the like. A method for conflict detection is discussed in more detail in FIG. 4 below.

In some embodiments, detection of conflicts is performed continuously. For example, according to an embodiment, a system, such as the controller 110, is configured to continuously receive SQL statements and detect conflicts based on the continuously received SQL statements and a shared data model to which the received SQL statements apply.

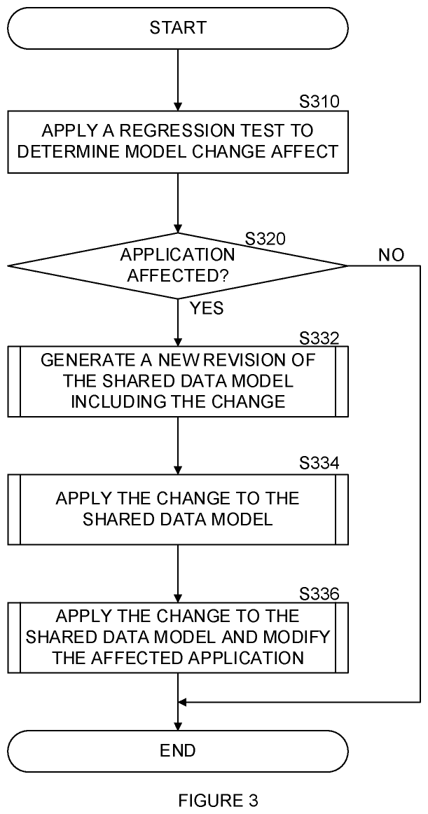

At S230, a check is performed to determine if a change should be applied to a received query or to a data model. In some embodiments, where a change is applied to the model, execution continues at a flowchart described in more detail in FIG. 3 below. In an embodiment, where a change is applied to the query, execution continues at S240.

In certain embodiments, the check includes receiving an input, for example from a user device, in response to providing the user device with a notification indicating that a conflict is detected between a query and a shared data model.

In some embodiments, the determination is performed based on a policy, a rule, a heuristic, and the like, which is applied to the query, the shared data model, a combination thereof, and the like. For example, in an embodiment, a query having a predefined conflict type (e.g., contradicting dimension), is always changed to a modified query based on a dimension type of the shared data model.

In an embodiment, a policy, a rule, a heuristic, and the like, include a conditional statement, such that where the conditional statement is met, an action is initiated. In other embodiments, a policy, a rule, a heuristic, and the like, include a conditional statement, such that where the conditional statement is not met, an action is initiated. In certain embodiments, an action includes adapting a query to the shared data model, adapting the shared data model, generating a new revision of an existing data model, a combination thereof, and the like.

At S240, the query is adapted. In an embodiment, adapting the query includes generating a new query based on the received query. For example, in an embodiment, adapting a query includes replacing a predicate, a filter, a dimension, a metric, a table, a formula, a sub-formula, a combination thereof, and the like. Examples of adapting queries based on detecting a conflict with a shared data model are discussed in more detail below.

At S250, a modified query is executed. In an embodiment, executing the modified query includes receiving an access credential, for example to access a data warehouse, and executing the query on the data warehouse.

In an embodiment, a data application includes a plurality of queries. In some embodiments, a portion of the queries are modified queries, and another portion of the queries are original queries. In an embodiment, the plurality of queries are executed in the data application.

FIG. 3 is an example flowchart of a method for adapting a shared data model to a data application, implemented according to an embodiment. In some embodiments, adapting the shared data model is performed based on a query of the data application.

At S310, a change affect is determined. In an embodiment, a first data application includes a query, based on which the shared data model is changed. In some embodiments, a change includes modifying a definition associated with a particular shared data model. Examples of changing a shared data model are discussed in more detail below.

In an embodiment, determining the change affect includes applying a regression test to determine where a change in a shared data model based on a query of a first application affects a second query of a second data application. In some embodiments, a plurality of second queries, second data applications, and the like, are detected.

At S320, a check is performed to determine if the change to the shared data model affects another data application. For example, in an embodiment, a change affect is determined where a data application includes a query which when applied to the shared data model produces a first result, and when applied to the changed shared data model produces a second result, does not produce a result (e.g., returns an error), and the like.

In an embodiment, where a data application is determined to be affected (i.e., ‘Yes’), execution continues at optional S332. In some embodiments, where a data application is determined not to be affected (i.e., ‘No’), execution terminates.

At optional S332, a new revision of the shared data model is generated. In some embodiments, a user account which authorizes a change to a shared data model does not have a permission to change an affected data application. In such embodiments, it is useful to generate a new revision of the shared data model, such that the new revision includes the change to the shared data model, and the previous (i.e., original) shared data model is preserved.

In an embodiment, the original shared data model is stale, i.e., the system does not utilize the original data model as an input, and affected data applications are transitioned from the original data model to the revised data model. In some embodiments, generating a new revision of the shared data model includes generating a new ELT standard file based on the previous shared data model and the change.

At optional S334, the change is applied to the shared data model. In some embodiments, option S334 occurs in response to detecting, at S320, that no data application other than a data application associated with the received query, is affected by the change to the shared data model.

In certain embodiments, applying the change to the shared data model includes updating an existing model, e.g., by replacing a definition of the shared data model with another definition. In some embodiments, applying the change to the shared data model includes generating a new model, based on the previous shared data model and a proposed change, a detected change, a plurality of changes, a combination thereof, and the like.

At optional S336, the change is applied and a data application is modified. In an embodiment, the change is applied to the shared data model, where the change affects a second data application. In an embodiment, the change is a result (e.g., a resolution) of a detected conflict between a first query of a first data application and the shared data model.

Where changing the shared data model to resolve the conflict between the shared data model and the first data application results in an effect on a second data application, an instruction is generated, according to an embodiment, to modify the second data application based on the changed shared data model. For example, in an embodiment, a second query of the second data application includes a term which is affected by the change to the shared data model. The term of the second query is adapted to the changed shared data model, so that the second data application can continue to be utilized.

FIG. 4 is an example flowchart of a method for detecting a conflict between a query and a shared data model, implemented in accordance with an embodiment.

At S410, a query is received. In an embodiment, the query is a structured query, such as a SQL query, directed to a shared data model. In some embodiments, the shared data model is implemented in an ELT standard, such as dbt™. In an embodiment, a plurality of queries are received. In some embodiments a data application is received, wherein the data application includes a plurality of queries.

In certain embodiments, each query of a plurality of queries is directed at a shared data model. In some embodiments, a first portion of the plurality of queries are directed at a first shared data model and a second portion of the plurality of queries are directed at a second shared data model.

In some embodiments, the query includes an access credential such as a user account identifier, an identity, a credential, a password, an API instruction, a combination thereof, and the like. In some embodiments, the access credential is utilized in executed the received query, for example by accessing a data warehouse and executing the query on data stored in the data warehouse.

At S420, a shared data model is accessed. In an embodiment, the shared data model is accessed by accessing a repository containing therein a data model, a plurality of shared data models, and the like. In some embodiments, the shared data model includes a version number, revision number, a modification date, a combination thereof, and the like.

In certain embodiments, accessing a shared data model includes receiving an access credential to access a repository in which the shared data model is stored. In an embodiment, a plurality of shared data models are accessed. In certain embodiments, a system is configured to perform a check, an authentication, a verification, a combination thereof, and the like, to confirm that a user account associated with the received query is authorized to access the shared data model.

At S430, a conflict is detected. In an embodiment, a conflict is detected by applying a heuristic, a policy, a rule, a condition, a combination thereof, and the like. In some embodiments, the heuristic, policy, rule, condition, etc. receive the shared data model and the received query as in input to detect a conflict between the shared data model and the received query.

In certain embodiments, the heuristic, policy, rule, and the like, include a conditional rule. For example, in an embodiment a conditional rule includes a Boolean logic expression, such as “IF condition X is satisfied THEN initiate instruction Y” where ‘X’ is a condition that is tested to be TRUE or FALSE, and ‘Y’ is an instruction, execution of which is initiated in response to determining that the condition ‘X’ is TRUE. Examples of applying heuristics are discussed in more detail below.

According to an embodiment, a system is configured to apply a heuristic to detect a dimension defined in an SQL statement that is not defined in the shared data model. For example, Model A is defined as:

SELECT f(c.*) AS b from c

Where f( ) represents an arbitrary scalar SQL function, and c is a dbt model. A SQL statement is received which includes:

SELECT g(c.*) AS d from c

As the Model A does not include the term “d”, there is a conflict. In an embodiment, the rule, policy, heuristic, and the like, further includes an instruction to modify Model A to resolve the conflict. For example, Model A is modified to:

SELECT f(c.*) AS b, g(c.*) AS d FROM c

Thus the conflict is resolved. In an embodiment, where the term ‘b’ is identical, semantically similar, and the like to the term ‘d’, an alternative heuristic, discussed in more detail below, is applied.

In an embodiment, a system is configured to apply a heuristic to detect a dimension defined in a received SQL statement which conflicts with an existing dimension in the shared data model. As in the example above, a model A is defined as:

SELECT f(c.*) AS b from c

and a SQL statement is received which includes:

SELECT g(c.*) AS d FROM c

where g( ) and f( ) are each arbitrary scalar SQL functions which are not identical, and the terms ‘b’ and ‘d’ are determined to be identical, semantically similar, and the like. For example, in an embodiment, two terms are considered semantically similar where a vector distance, such as determined by applying Word2Vec is below a predetermined threshold.

In certain embodiments, a system is configured to change the shared data model, for example by modifying the definition of the model A to:

SELECT g(c.*) AS d FROM c

In other embodiments, the system is configured to adapt the SQL statement to:

SELECT b FROM A

Thus the conflict is resolved. In certain embodiments, a system is configured to receive a user input to determine if the SQL statement or the shared data model should be modified. In other embodiments, a heuristic, a rule, a policy, and the like, include a predetermined definition to modify either the SQL statement or the shared data model. For example, in an embodiment, the predetermined definition is determined based on a user account which generated the SQL statement.

In some embodiments, a system is configured to apply a heuristic to detect a dimension defined in the SQL statement that is already defined in the shared data model, having a different name. For example, a model A is defined:

SELECT*, f(c.*) AS b FROM c

and a SQL statement is received which includes:

SELECT*, f(c.*) AS d FROM c

As another example, a second SQL statement which is received includes:

SELECT f(A.*) AS d FROM A

Here, the conflict is due to the same dimension being given two names which are distinct. The conflict is resolved, according to an embodiment by modifying the SQL statement to:

SELECT*, f(c.*) AS b FROM c

In another embodiment, the conflict is resolved by modifying the model A to:

SELECT*, f(c.*) AS d FROM c

thus resulting in resolution of the conflict.

According to an embodiment, a system is configured to apply a heuristic to detect a measure, a metric, and the like, which is defined in an SQL statement and missing from the shared data model. For example, a model A is defined as:

SELECT agg(b.*) AS measure1 FROM b WHERE f(b.*) GROUP BY h(b.*)

where agg( ) is an arbitrary aggregation function in SQL. A SQL statement is received which includes:

SELECT agg2(b.*) AS measure2 FROM b WHERE f(b.*) AND g(b.*) GROUP BY h(b.*)

where agg2( ) is an arbitrary aggregation function, and h( ) is an arbitrary scalar function. The model A conflicts with the SQL statement with a pre-aggregation, and is modified to:

SELECT agg(b.*) AS measure1, agg2(SELECT b.* WHERE g(b.*)) AS measure2 FROM b WHERE f(b.*) GROUP BY h(b.*)

and the SQL statement is modified to:

SELECT measure2 FROM A

which resolves the conflict.

In some embodiments, a system is configured to apply a heuristic to detect a SQL statement which can utilize a pre-aggregate model, but does not do so. For example, a model A is defined as:

SELECT agg(b.*) AS measure1 FROM b GROUP BY f(b.*)

and a SQL statement is received which includes:

SELECT agg(b.*) AS measure1 FROM b GROUP BY g(b.*)

where g(b.*) is a coarser projection than f(b.*), i.e., g(b.*) can be expressed as h(f(b.*)). The SQL statement is in conflict with the heuristic, as it does not make use of the pre-aggregated model. The SQL statement is modified, in an embodiment, to:

SELECT measure1FROM A GROUP BY g(A.*)

Certain embodiments include a system which is configured to apply a heuristic to detect a pre-aggregated model that is projecting data in a way that is too coarse to service a data application represented by a received SQL statement. For example, a model A is defined as:

SELECT agg(b.*) AS measure1 FROM b GROUP BY f(g(b.*))

and a SQL statement is received which includes:

SELECT agg(b.*) AS measure1 FROM b GROUP BY g(b.*)

where agg( ) in this example is also commutative. In this embodiment, the model A is performing pre-aggregation of table ‘b’, but the projection is too coarse to service the data application represented in the SQL statement. According to an embodiment, a new model is generated defined as:

SELECT agg(b.*) AS measure1 FROM b GROUP BY g(b.*)

the model A is modified to:

SELECT agg (measure1) FROM B GROUP BY f(B.*)

and the SQL statement is further modified to:

SELECT measure1 FROM B

Some embodiments include a system which is configured to apply a heuristic to detect a relationship between a first table and a second table that is defined in the SQL statement but is not defined in the shared data model. For example, a model A is defined as:

SELECT g(b.*) AS c FROM d

where a received SQL statement includes:

SELECT f(A.*, b.*) FROM A [LEFT|FULL] JOIN b [ON|USING . . . ]

In some embodiments, the model A is modified to be defined as:

SELECT A.*, b.*, g(b.*) AS c FROM d [LEFT\FULL] JOIN b [ON|USING . . . ]

and the SQL statement is amended to utilize the modified model A. In certain embodiments, a new model B is defined as:

SELECT A.*, b. * FROM A [LEFT\FULL] JOIN b [ON|USING . . . ]

and the SQL statement is modified to utilize the new model B.

According to an embodiment, a system is configured to apply a heuristic to detect a model which is embedded as a common table expression (CTE), a subquery in a SQL statement, and the like, which should be full models in the shared data model. A CTE, is, according to an embodiment, a “WITH” expression.

For example, in an embodiment, a model A is defined as:

WITH cte AS (SELECT f(b.*) FROM b WHERE g(b.*) GROUP BY h(b.*)) SELECT j(cte.*) FROM cte

and a SQL statement is received which includes:

WITH other_cte AS (SELECT f(b.*) FROM b WHERE g(b.*) GROUP BY h(b.*)) SELECT k(other_cte.*) AS k FROM other_cte

The CTE is duplicated between model A and the SQL statement, which violates a principal of DRY (don't repeat yourself). In an embodiment, the conflict is resolved by defining a new model B. For example, the model B is defined as:

SELECT f(b.*) FROM b WHERE g(b.*) GROUP BY h(b.*)

and model A is modified to:

SELECT j(B.*) FROM B

where the SQL statement is further modified to:

SELECT k(B.*) AS k FROM B

thus resolving the conflict.

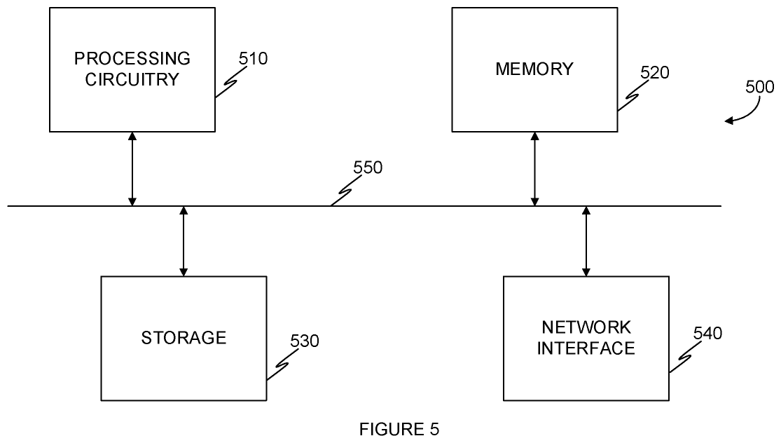

FIG. 5 is an example schematic diagram 500 of a controller 110 according to an embodiment. The controller 110 includes a processing circuitry 510 coupled to a memory 520, a storage 530, and a network interface 540. In an embodiment, the components of the controller 110 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof. In an embodiment, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein may be stored in the storage 530, in the memory 520, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 540 is configured to provide the controller 110 with communication with, for example, the agent 120.

It should be understood that the embodiments described herein are not limited to the specific architecture illustrated in FIG. 5, and other architectures may be equally used without departing from the scope of the disclosed embodiments.

Furthermore, in certain embodiments the agent 120 may be implemented with the architecture illustrated in FIG. 5. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for dynamically adapting a query and shared data model, comprising:
receiving a structured query directed to a shared data model;
apply a plurality of heuristics to the received structured query and the shared data model;
detecting a conflict between a first element of the structured query and a first element of the shared data model based on a first heuristic of the plurality of heuristics;
generating a new structured query based on the received structured query and a first result, in response to detecting the first result of applying the first heuristic; and
generating a modified shared data model based on the shared data model and a second result, in response to detecting the second result of applying a second heuristic of the plurality of heuristics.

2. The method of claim 1, further comprising:
generating a change request to generate the modified shared data model; and
initiating a regression test on the change request.

3. The method of claim 2, further comprising:
identify an impacted software application utilizing the modified shared data model based on a result of the regression test.

4. The method of claim 3, further comprising:
generating the modified shared data model for the impacted software application; and
assigning an unimpacted software to the shared data model.

5. The method of claim 3, further comprising:
generating a software application update to update the impacted software application to utilize the modified shared data model.

6. The method of claim 5, further comprising:
generating a binary code based on the impacted software application; and
replacing a portion of code of the impact software application with the generated binary code.

7. The method of claim 1, further comprising:
detecting a dimension identifier in the received structured query which is not defined in the shared data model; and
detecting the conflict based on the detected dimension.

8. The method of claim 1, further comprising:
detecting a measure identifier in the received structured query which is not defined in the shared data model; and
detecting the conflict based on the detected measure.

9. A non-transitory computer-readable medium storing a set of instructions for dynamically adapting a query and shared data model, the set of instructions comprising:
one or more instructions that, when executed by one or more processors of a device, cause the device to:
receive a structured query directed to a shared data model;
apply a plurality of heuristics to the received structured query and the shared data model;
detect a conflict between a first element of the structured query and a first element of the shared data model based on a first heuristic of the plurality of heuristics;
generate a new structured query based on the received structured query and the first result, in response to detecting a first result of applying the first heuristic; and
generate a modified shared data model based on the shared data model and a second result, in response to detecting the second result of applying a second heuristic of the plurality of heuristics.

10. A system for dynamically adapting a query and shared data model comprising:
a processing circuitry;
a memory, the memory containing instructions that, when executed by the processing circuitry, configure the system to:
receive a structured query directed to a shared data model;
apply a plurality of heuristics to the received structured query and the shared data model;
detect a conflict between a first element of the structured query and a first element of the shared data model based on a first heuristic of the plurality of heuristics;
generate a new structured query based on the received structured query and the first result, in response to detecting a first result of applying the first heuristic; and
generate a modified shared data model based on the shared data model and a second result, in response to detecting the second result of applying a second heuristic of the plurality of heuristics.

11. The system of claim 10, wherein the memory contains further instructions which when executed by the processing circuitry further configure the system to:
generate a change request to generate the modified shared data model; and
initiate a regression test on the change request.

12. The system of claim 11, wherein the memory contains further instructions which when executed by the processing circuitry further configure the system to:
identify an impacted software application utilize the modified shared data model based on a result of the regression test.

13. The system of claim 12, wherein the memory contains further instructions which when executed by the processing circuitry further configure the system to:
generate the modified shared data model for the impacted software application; and
assign an unimpacted software to the shared data model.

14. The system of claim 12, wherein the memory contains further instructions which when executed by the processing circuitry further configure the system to:
generate a software application update to update the impacted software application to utilize the modified shared data model.

15. The system of claim 14, wherein the memory contains further instructions which when executed by the processing circuitry further configure the system to:
generate a binary code based on the impacted software application; and
replace a portion of code of the impact software application with the generated binary code.

16. The system of claim 10, wherein the memory contains further instructions which when executed by the processing circuitry further configure the system to:
detect a dimension identifier in the received structured query which is not defined in the shared data model; and
detect the conflict based on the detected dimension.

17. The system of claim 10, wherein the memory contains further instructions which when executed by the processing circuitry further configure the system to:
detect a measure identifier in the received structured query which is not defined in the shared data model; and
detect the conflict based on the detected measure.
